(19) United States
(12) Patent Application Publication
(10) Pub. No.: US 2025/0372282 A1
(43) Pub. Date: Dec. 4, 2025

(54) CABLE AND METHOD OF MAKING SAME

(71) Applicants: FOXCONN (KUNSHAN) COMPUTER CONNECTOR CO., LTD., Kunshan (CN); FOXCONNINTERCONNECT TECHNOLOGY LIMITED, Grand Cayman (KY)

(72) Inventors: JIAN-GUO CAI, Kunshan (CN); JUAN ZHENG, Kunshan (CN); LU-YU CHANG, New Taipei (TW)

(21) Appl. No.: 19/219,260

(22) Filed: May 27, 2025

(30) Foreign Application Priority Data
May 29, 2024 (CN) 202410683818.1

(51) Int. Cl. H01B 7/18; H01B 7/02; H01B 13/22

(52) U.S. Cl. CPC H01B 7/1805; H01B 7/0216; H01B 13/22

(57) ABSTRACT

A cable includes: a pair of inner conductors; an insulating layer covering the pair of inner conductors; a shielding layer disposed outside the insulating layer; and an outer layer covering the shielding layer; wherein the shielding layer is fastened to the surface of the insulating layer and completely isolates the insulating layer from air.

### BACKGROUND OF THE INVENTION

### Field of the Invention

The present invention relates generally to a cable and method of making the same, and more particularly to a cable that has good electrical performance to transmit high-frequency signals.

### Description of Related Arts

With the development and popularization of electronic technology products, cables are widely used in household appliances, instrumentation, automation equipment, data centers, servers, switches, cloud computing and 5G as a tool for signal transmission. However, during signal transmission process, the cable is susceptible to interference from external electromagnetic signals so it is often necessary to use a shielding structure to eliminate or reduce the interference of the external electromagnetic field and to prevent the leakage of the transmission signal.

CN Patent Application Publication No. 109545463 discloses a cable comprising a conductor, an insulative layer covering the conductor, a first shielding layer and a second shielding layer covering the insulative layer. The shielding layer is a metal foil, which is wrapped around or longitudinally wrapped outside the insulating layer. That free air may exist between the insulating layer and the metal foil, the metal foil junctions are not airtight, the metal foil wrapping is not flat, etc., all will affect signal transmission.

Therefore, it is desired to provide an improved cable with good shielding effect.

### SUMMARY OF THE INVENTION

A main object of the present invention is to provide a cable with good shielding effect and good conductive continuity, and a method of making the same.

To achieve the above object, a cable includes: a pair of inner conductors; an insulating layer covering the pair of inner conductors; a shielding layer disposed outside the insulating layer; and an outer layer covering the shielding layer; wherein the shielding layer is fastened to the surface of the insulating layer and completely isolates the insulating layer from air.

To achieve the above object, a method of making a cable comprises the steps of: covering an inner conductor with an insulating layer; forming a shielding layer on the surface of the insulating layer to fasten to the surface of the insulating layer and completely isolate the insulating layer from air; and covering the shielding layer with an outer layer.

Compared to prior art, the shielding layer in the present invention is fastened to the surface of the insulating layer and the insulating layer is completely isolated from the air, which has better conductivity continuity and anti-electromagnetic interference capability.

### BRIEF DESCRIPTION OF THE DRAWING

FIG. 1 is a cross-sectional view of a first embodiment of a cable of the present invention;

FIG. 2 is a cross-sectional view of a second embodiment of a cable of the present invention;

FIG. 3 is a cross-sectional view of a third embodiment of a cable of the present invention;

FIG. 4 is a cross-sectional view of a forth embodiment of a cable of the present invention;

FIG. 5 is a cross-sectional view of a fifth embodiment of a cable of the present invention;

FIG. 6 is a cross-sectional view of a sixth embodiment of a cable of the present invention;

FIG. 7 is a cross-sectional view of a seventh embodiment of a cable of the present invention;

FIG. 8 is a cross-sectional view of a eighth embodiment of a cable of the present invention;

FIG. 9 is a cross-sectional view of a ninth embodiment of a cable of the present invention; and

FIG. 10 is a cross-sectional view of a tenth embodiment of a cable of the present invention.

### DETAILED DESCRIPTION OF THE PREFERRED EMBODIMENT

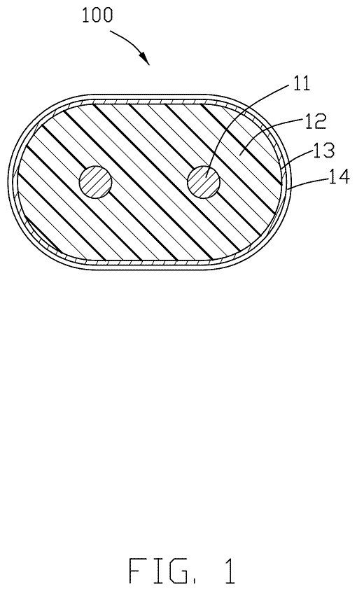

Referring to FIG. 1, the first embodiment of the cable 100 of the present invention is shown. The cable 100 comprises a pair of inner conductors 11, an insulating layer 12 covering the inner conductor 11, a shielding layer 13 covering the insulating layer 12, and an outer layer 14 covering the shielding layer 13.

The pair of inner conductors 11 spaced apart in a transverse direction. The inner conductor 11 is selected from the group consisting of copper, silver-plated copper or tin-plated copper. The insulating layer 12 covering the pair of inner conductors 11 by extrusion molding. The insulating layer 12 can be one of foamed PP (polypropylene), foamed PE (polyethylene), foamed FEP (Fluorinated ethylene propylene), solid PP, solid PE, solid FEP, or solid PTFE (Polytetrafluoroethylene). The outer layer 14 is made of PET (Polyethylene terephthalate).

The shielding layer 13 is fastened to the surface of the insulating layer 12 and completely isolates the insulating layer 12 from the air. Specifically, the shielding layer 13 is a conductive coating coated on the surface of the insulating layer 12. The conductive coating is made by adding conductive material particles into the filler of the coating, and spraying, printing or brushing it onto the surface of the insulating layer 12 together with an organic or inorganic binders and diluents to form a conductive layer with conductive ability. According to requirements, the content of conductive particles in the filler can be adjusted, or the resistivity of the conductive coating can be adjusted by using conductive particles with different resistivities. The conductive coating may also be a conductive coating filled with metal particles. The coating filled with metal particles is applied to the outer surface of the insulating layer 12 by spraying, printing, brushing, etc., to form the conductive coating.

The shielding layer 13 can also be formed by vacuum metallization technology, which uses vacuum technology to deposit a metal film on the surface of the insulating layer 12 to form a conductive layer.

The shielding layer 13 can also be formed by directly spraying the molten metal liquid on the surface of the insulating layer 12 through thermal spraying technology to form a conductive layer. The thickness of the conductive layer is 25-50 microns.

The shielding layer 13 can also be bonded to the surface of the insulating layer 12 by first applying glue to the surface of the insulating layer 12 and then spraying metal powder. After drying, the insulating layer 12 and the metal powder are bonded together.

The shielding layer 13 can also be electroplated on the insulating layer 12. A thin layer of metal or alloy is plated on the insulating layer 12. The process of using electrolysis to attach a metal film to the surface of the insulating layer, thereby preventing metal oxidation and improving wear resistance, conductivity, reflectivity, corrosion resistance, etc.

The shielding layer 13 can be coated, vacuum metallized, thermally sprayed, bonded, or electroplated on the surface of the insulating layer 12. The shielding layer 13 of the present invention forms a complete conductive layer on the surface of the insulating layer 12 to achieve the purpose of shielding electromagnetic waves. In addition, the shielding layer 13 of the present invention can form a very tight protective layer on the surface of the insulating layer 12, and has a high bonding with the insulating layer 12. Compared with the traditional wrapping process of aluminum foil, copper foil and other metal foils, the present invention can perfectly solve the influence of factors such as free air between the insulating layer 12 and the metal foil, the unsealed metal foil overlap interface, and the uneven metal foil coating on the transmission signal. The shielding layer 13 of the present invention has better conductivity consistency and anti-electromagnetic interference ability, so the shielding effect is better.

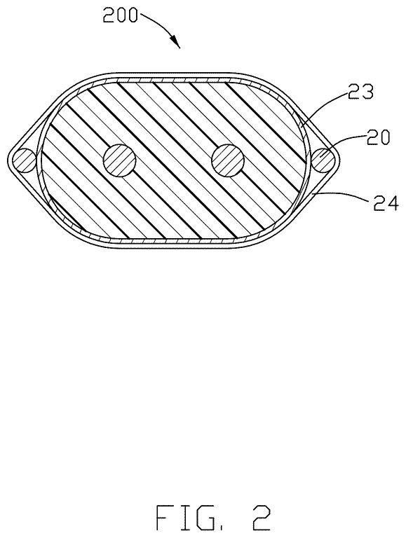

FIG. 2 shows the second embodiment of a cable 200 of the present invention. Compared with the first embodiment, in this embodiment, the cable 200 further comprises a pair of ground wires 20. The pair of ground wires 20 are disposed between the shielding layer 23 and the outer layer 24, and are located on the left and right sides of the shielding layer 23 respectively.

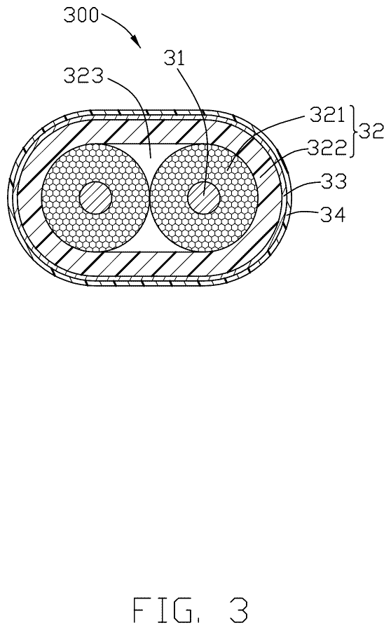

FIG. 3 shows the third embodiment of a cable 300 of the present invention. Compared with the first embodiment, in this embodiment, the insulating layer 32 includes a first insulating layer 321 and a second insulating layer 322. The first insulating layer 321 is made of foam material, and the second insulating layer 322 is made of solid material. The first insulating layer 321 is covered on the outside of each inner conductor 31 by extrusion molding, and is concentric with the corresponding inner conductor 31, the outer surfaces of the first insulating layers 321 outside the two inner conductors 31 are in contact with each other. The second insulating layer 322 covers the first insulating layers 321, and two air gaps 323 is formed between the second insulating layer 322 and the first insulating layer 321 at the upper and lower sides. The shielding layer 33 is disposed on the outer surface of the second insulating layer 322. The outer layer 34 is covered on the outer surface of the shielding layer 33.

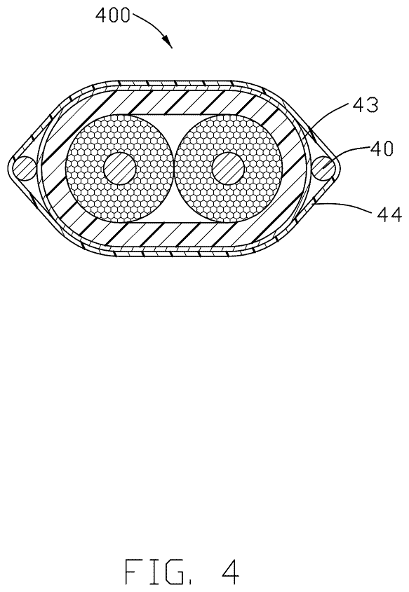

FIG. 4 shows the fourth embodiment of a cable 400 of the present invention. Compared with the third embodiment, in this embodiment, the cable 400 further comprises a pair of ground wires 40. The pair of ground wires 40 are disposed between the shielding layer 43 and the outer layer 44 and are located on the left and right sides of the shielding layer 43 respectively.

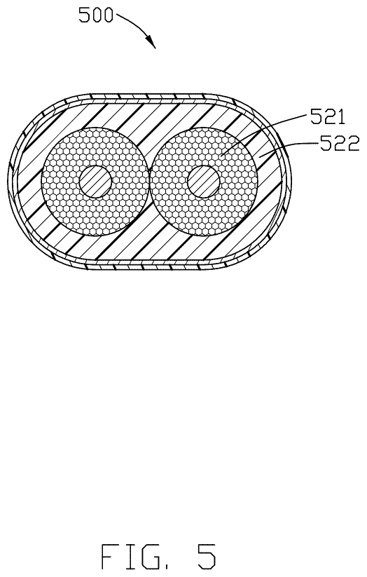

Referring to FIG. 5 shows the fifth embodiment of a cable 500 of the present invention. Compared with the third embodiment, in this embodiment, there is no air gap between the second insulating layer 522 and the first insulating layer 521.

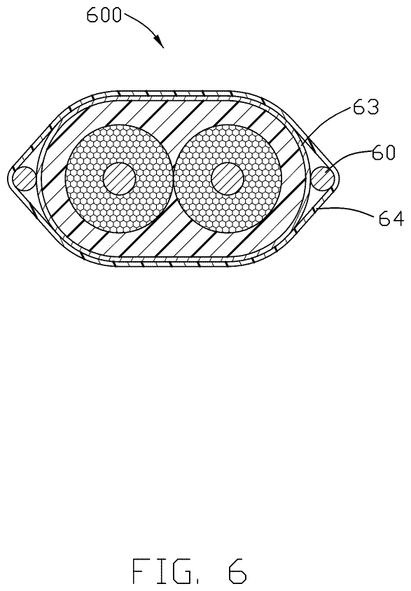

FIG. 6 shows the sixth embodiment of a cable 600 of the present invention. Compared with the fifth embodiment, in this embodiment, the cable 600 further comprises a pair of ground wires 60. The pair of ground wires 60 are disposed between the shielding layer 63 and the outer layer 64 and are located on the left and right sides of the shielding layer 63 respectively.

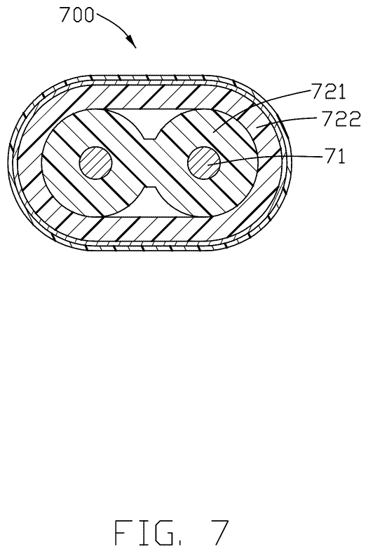

FIG. 7 shows the seventh embodiment of a cable 700 of the present invention. Compared with the third embodiment, in this embodiment, the first insulating layer 721 is common formed outside the pair of inner conductors 71 to form a horizontal “8”-shaped structure. The second insulating layer 722 is formed outside the first insulating layer 721, and two air gaps 723 are formed on the upper and lower sides of the first insulating layer 721. The first insulating layer 721 and the second insulating layer 722 are both made of solid material.

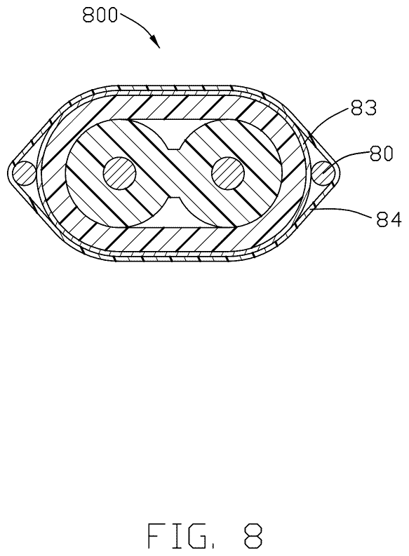

FIG. 8 shows the sixth embodiment of a cable 800 of the present invention. Compared with the seventh embodiment, in this embodiment, the cable 800 further comprises a pair of ground wires 80. The pair of ground wires 80 are arranged between the shielding layer 83 and the outer layer 84 and are located on the left and right sides of the shielding layer.

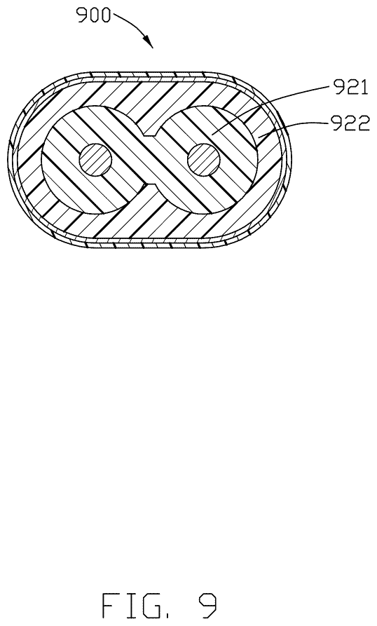

FIG. 9 shows the sixth embodiment of a cable 900 of the present invention. Compared with the seventh embodiment, in this embodiment, there is no air gap between the second insulating layer 922 and the first insulating layer 921

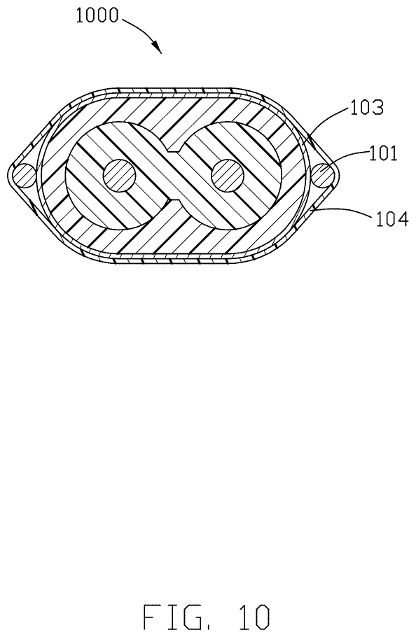

FIG. 10 shows the sixth embodiment of a cable 1000 of the present invention. Compared with the ninth embodiment, in this embodiment, the cable 1000 further comprises a pair of bare ground wires 101. The pair of bare ground wires 101 are arranged between the shielding layer 103 and the outer layer 104 and are located on the left and right sides of the shielding layer 103 respectively.

A method of making the cable 100, comprising the steps of: covering the inner conductor 11 with the insulating layer 12; forming a shielding layer 13 outside the insulating layer 12, and the shielding layer 13 is fastened to the outside of the insulating layer so that the insulating layer is completely isolated from air; and covering the outer layer 14 outside the shielding layer 13.

In the present invention, the shielding layer 13 of the cable is fastened to the surface of the insulating layer 12 so that the insulating layer 12 is completely isolated from the air. The shielding layer 13 has better consistency and symmetry, better conductive continuity and anti-electromagnetic interference capability, and better shielding effect.

1. A cable comprising:
a pair of inner conductors;
an insulating layer covering the pair of inner conductors;
a shielding layer disposed outside the insulating layer; and
an outer layer covering the shielding layer; wherein
the shielding layer is fastened to the surface of the insulating layer and completely isolates the insulating layer from air.

2. The cable as claimed in claim 1, wherein the shielding layer is coated, vacuum metallized, thermally sprayed, bonded, or electroplated on the surface of the insulating layer.

3. The cable as claimed in claim 1, wherein the shielding layer includes a coating filled with metal particles.

4. The cable as claimed in claim 3, wherein the coating filled with metal particles is applied to the outer surface of the insulating layer by spraying, printing, or brushing to form the shielding layer.

5. The cable as claimed in claim 1, wherein the thickness of the shielding layer is 25-50 microns.

6. The cable as claimed in claim 1, wherein the inner conductor is selected from the group consisting of copper, silver-plated copper or tin-plated copper.

7. The cable as claimed in claim 1, wherein the insulation layer is selected from the group consisting of foamed PP, foamed PE, foamed FEP, solid PP, solid PE, solid FEP, and solid PTFE.

8. The cable as claimed in claim 1, wherein the pair of inner conductors are arranged at intervals in the transverse direction, the insulating layer comprises a first insulating layer and a second insulating layer, the first insulating layer is covered on the corresponding inner conductor by extrusion molding, and the second insulating layer covers the first insulating layers.

9. The cable as claimed in claim 8, wherein the first insulating layer is made of foam material, and the second insulating layer is made of solid material.

10. The cable as claimed in claim 8, wherein the first insulating layer and the second insulating layer are both made of solid material.

11. The cable as claimed in claim 8, wherein two air gaps are formed on the upper and lower sides of the first insulating layer.

12. The cable as claimed in claim 8, wherein there is no air gap between the second insulating layer and the first insulating layer.

13. The cable as claimed in claim 1, further comprising a pair of ground wires disposed between the shielding layer and the outer layer, and the pair of ground wires are located on two sides of the shielding layer respectively

14. A method of making a cable, comprising the steps of:
covering an inner conductor with an insulating layer;
forming a shielding layer on the surface of the insulating layer to fasten to the surface of the insulating layer and completely isolate the insulating layer from air; and
covering the shielding layer with an outer layer.

15. The method as claimed in claim 14, wherein the step of forming comprises coating, vacuum metallization, thermal spraying, bonding, or electroplating a conductive coating on the surface of the insulating layer.

16. The method as claimed in claim 15, wherein the conductive coating is formed by first mixing fine particles of conductive material into filler and then spraying, printing or brushing on the surface of the insulating layer together with a binder and a diluent.
